(19) United States
(12) Patent Application Publication
(10) Pub. No.: US 2014/0225844 A1
(43) Pub. Date: Aug. 14, 2014

(54) DISPLAY DEVICE AND TOUCH PANEL

(71) Applicant: Japan Display Inc., Minato-ku (JP)

(72) Inventors: Masahiro TADA, Tokyo (JP); Yutaka Umeda, Tokyo (JP); Takashi Nakamura, Tokyo (JP); Hirotaka Hayashi, Tokyo (JP)

(73) Assignee: Japan Display Inc., Minato-ku (JP)

(21) Appl. No.: 14/151,181

(22) Filed: Jan. 9, 2014

(30) Foreign Application Priority Data
Feb. 8, 2013 (JP) 2013-023060

(51) Int. Cl. G06F 3/01; G06F 3/041

(52) U.S. Cl. CPC G06F 3/016; G06F 3/041
USPC 345/173

(57) ABSTRACT

According to one embodiment, a touchpanel includes, a plurality of electrodes arranged in each of a first direction and a second direction on the touchpanel, a module configured to supply a signal for detecting a position of a conductor on the touchpanel to each of the electrodes, and configured to compute the position of the conductor based on a signal output from the electrode, a module configured to output a tactile signal to an electrode in a vicinity to the position of the conductor, a module configured to switch between a signal line from the touch detection module and a signal line from the tactile output module, and to connect the signal line to a signal line from each of the electrodes, and a control module configured to control operations of the modules.

### CROSS-REFERENCE TO RELATED APPLICATIONS

This application is based upon and claims the benefit of priority from Japanese Patent Application No. 2013-023060, filed Feb. 8, 2013, the entire contents of which are incorporated herein by reference.

### FIELD

Embodiments described herein relate generally to a display device and a touch panel.

### BACKGROUND

An electronic apparatus such as a mobile phone, a portable information terminal or a personal computer equipped with a display device comprising a touchpanel function as a form of a user interface has been developed. Adding the touchpanel function to a display apparatus such as a liquid crystal display device or an organic EL display device by bonding a separate touchpanel substrate to the device in such an electronic apparatus comprising a touchpanel function is considered.

Incidentally, when a mechanical push button is pushed down, the button is moved and a touch surface becomes uneven, and a user can recognize the button which the user has pressed and execution of input by tactile feeling. However, such tactile feeling cannot be obtained since the touchpanel has no button movement or an uneven touch surface. Thus, various methods for artificially producing the tactile feeling are proposed.

### BRIEF DESCRIPTION OF THE DRAWINGS

FIG. 1 is an exemplary cross-sectional view showing a structure of a display device according to a first embodiment;

FIG. 2 is an exemplary illustration showing a structure of a touchpanel of the display device according to the first embodiment;

FIG. 3 is an exemplary diagram showing an operation principle of the touchpanel of the display device according to the first embodiment;

FIG. 4 is an exemplary diagram showing a detailed structure of the touchpanel of the display device according to the first embodiment;

FIG. 5 is an exemplary driving timing chart in a case where detection of finger is executed by a mutual capacitance change of the touchpanel of the display device according to the first embodiment;

FIG. 6 is an exemplary driving timing chart in a case where detection of finger is executed by a self capacitance change of the touchpanel of the display device according to the first embodiment;

FIG. 7 is an exemplary diagram showing a detailed structure of a touchpanel of a display device according to a second embodiment;

FIG. 8 is an exemplary driving timing chart of the touchpanel of the display device according to the second embodiment;

FIG. 9A is an exemplary diagram for illustrating various driving methods of a touchpanel and a display module in a display device according to a third embodiment;

FIG. 9B is an exemplary diagram for illustrating various driving methods of the touchpanel and the display module in the display device according to the third embodiment;

FIG. 9C is an exemplary diagram for illustrating various driving methods of the touchpanel and the display module in the display device according to the third embodiment;

FIG. 10 is an exemplary illustration showing a configuration of electrodes of a touchpanel of a display device according to a fourth embodiment;

FIG. 11 is an exemplary illustration showing a configuration of electrodes of the touchpanel of the display device according to the fourth embodiment;

FIG. 12 is an exemplary illustration showing a configuration of electrodes of the touchpanel of the display device according to the fourth embodiment;

FIG. 13A is an exemplary illustration showing a structure of a tactile signal of a touchpanel of a display device according to a fifth embodiment; and

FIG. 13B is an exemplary illustration showing a structure of a tactile signal of the touchpanel of the display device according to the fifth embodiment.

### DETAILED DESCRIPTION

In general, according to one embodiment, a touchpanel includes a plurality of electrodes arranged in each of a first direction and a second direction crossing the first direction on the touchpanel, a touch detection module comprising a detection signal output module configured to supply a signal for detecting a position of a conductor on the touchpanel to each of the electrodes and a position computing module configured to compute the position of the conductor based on a signal output from the electrode in accordance with the supplied signal, a tactile output module configured to output a tactile signal to an electrode in a vicinity to the position of the conductor, a switching module configured to switch between a signal line from the touch detection module and a signal line from the tactile output module, and to connect the signal line to a signal line from each of the electrodes, and a control module configured to control operations of the touch detection module, the tactile output module and the switching module.

### First Embodiment

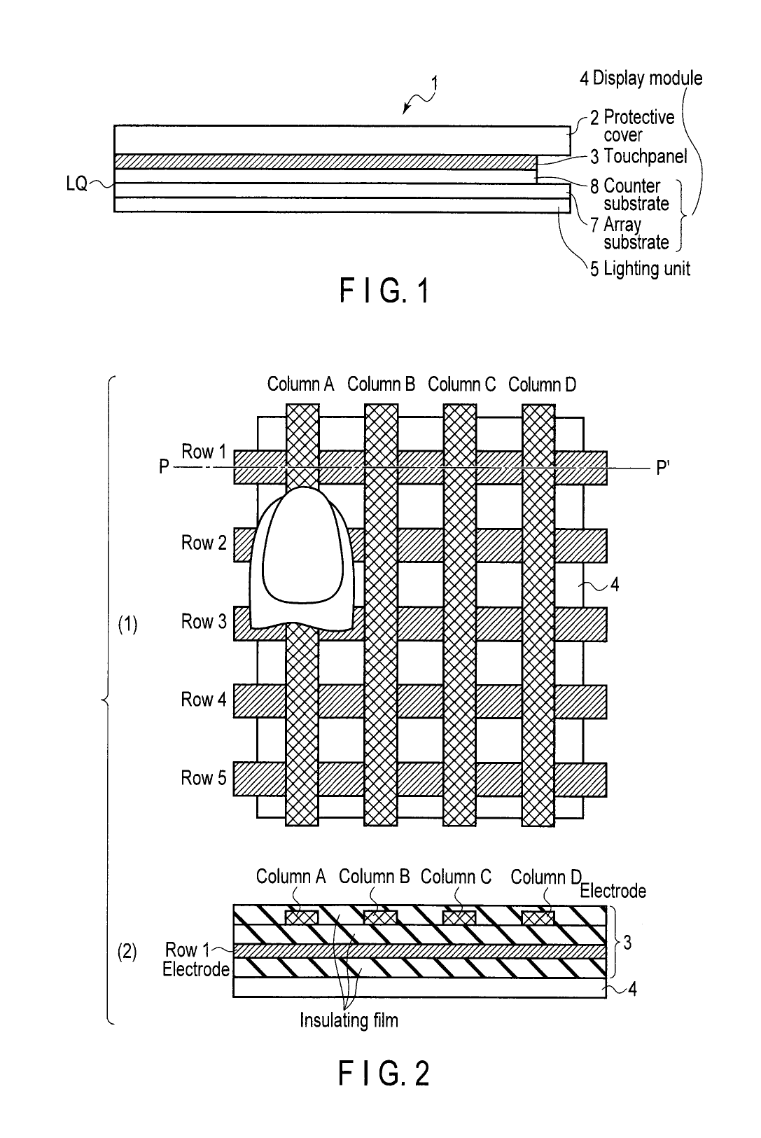

FIG. 1 is a cross-sectional view showing a structure of a display device according to a first embodiment.

The display device 1 according to the first embodiment comprises a protective cover 2, a touchpanel 3, a display module 4 and a lighting unit 5. The display module 4 of the first embodiment is, for example, a liquid crystal display panel. The display module 4 may be formed as a flat display using an organic light emitting diode (OLED) or the like. If the display module 4 is a self-luminous display using such as an OLED, the lighting unit 5 can be omitted.

The touchpanel 3 detects an access position or a contact position of a dielectric such as a finger by a detection electrode. The detection electrode is a transparent electrode using a material such as indium tin oxide (ITO) or a silver nanowire. For example, the detection electrodes are arranged on a substrate made of glass, plastic or the like as a number of electrodes arranged vertically and horizontally in a mosaic pattern.

The display module 4 has a structure of sandwiching a liquid crystal layer LQ between an array substrate 7 and a counter substrate 8 that are a pair of electrode substrates. Transmittance of a liquid crystal display panel PNL is controlled by a liquid crystal driving voltage applied from a pixel electrode PE provided on the array substrate 7 and a common electrode CE provided on the counter substrate 8 to the liquid crystal layer LQ.

The protective cover protects the touchpanel 3 and the display module 4 from external impact. The protective cover is made of glass, but may be formed as a transparent dielectric such as acryl, polycarbonate or PET, or a material having electrical conductivity of about 1E5Ω/□-1E10Ω/□.

FIG. 2 is an illustration showing a structure of the touchpanel 3 of the display device 1 according to the first embodiment. FIG. 2(1) is a plan view, and FIG. 2(2) is a cross-sectional view seen along arrow P-P′.

On the touchpanel 3, a plurality of transparent row electrodes (row 1, row 2 . . . ) extending in a horizontal direction and a plurality of transparent column electrodes (column A, column B . . . ) extending in a vertical direction are provided in a lattice pattern as shown in FIG. 2(1). The row electrodes and the column electrodes are arranged in different layers via a transparent insulating film.

FIG. 2(1) shows a state in which a finger touches a vicinity to an intersection point of the row electrode in row 2 and the column electrode in column A, on the touchpanel 3. In this case, mutual capacitance of the row electrode in row 2 and the column electrode in column A is varied by existence of the finger which is a dielectric. Accordingly, the existence position of the finger can be detected by measuring the mutual capacitance of the row electrode and the column electrode. Furthermore, a self capacitance of the row electrode in row 2 or a self capacitance of the column electrode in column A is varied by the existence of the finger which is a dielectric. Accordingly, the existence position of the finger can be detected by measuring the self capacitance of the row electrode or the column electrode.

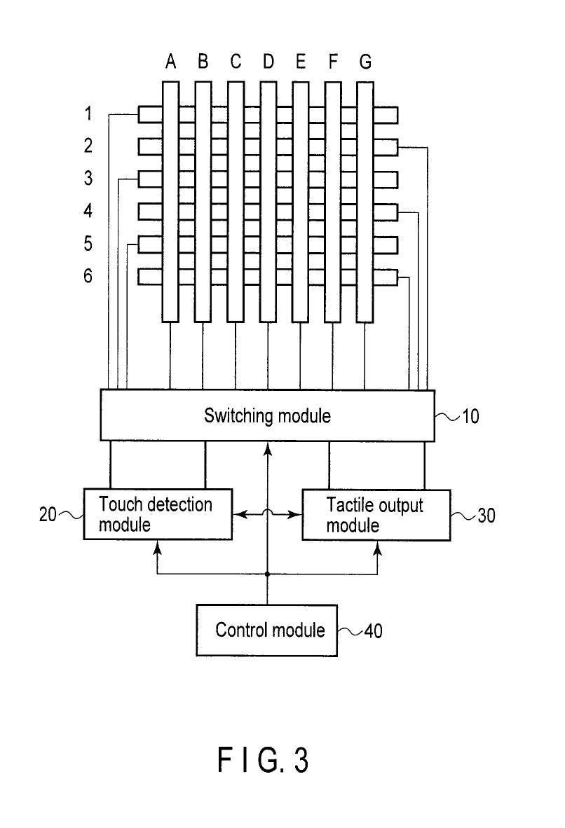

FIG. 3 is a diagram showing an operating principle of the touchpanel 3 of the display device 1 according to the first embodiment.

Signal lines connected to the respective row electrodes (row 1, row 2 . . . ) and the column electrodes (column A, column B . . . ) are connected to a switching module 10. Furthermore, a signal line from a touch detection module 20 and a signal line from a tactile output module 30 are connected to the switching module 10. The switching module 10 switches between the signal line from the touch detection module 20 and the signal line from the tactile output module 30, connects these signal lines to the signal lines from the respective electrodes, and thereby enables a touch detection operation and a tactile output operation to be executed in time division.

The touch detection module 20 supplies a signal to each of the electrodes and detects the existence position of the finger. The tactile output module 30 applies a voltage to an electrode arranged in the position in which the finger exists and provides tactile feeling to the finger. That is, in the display device 1 of the first embodiment, the electrodes share a function to detect a finger which is a dielectric and a function to supply a tactile signal to the finger. Since an electrode for tactile sense can comprise the same resolution as the detection electrode, the electrode for tactile sense can feed back a tactile signal by which the touched position can be discriminated with a high degree of accuracy.

The switching module 10, the touch detection module 20, the tactile output module 30 and a control module 40 configured to control operations thereof may be provided on an external circuit substrate (not shown).

Next, the operations of the touch detection and the tactile output will be described in detail.

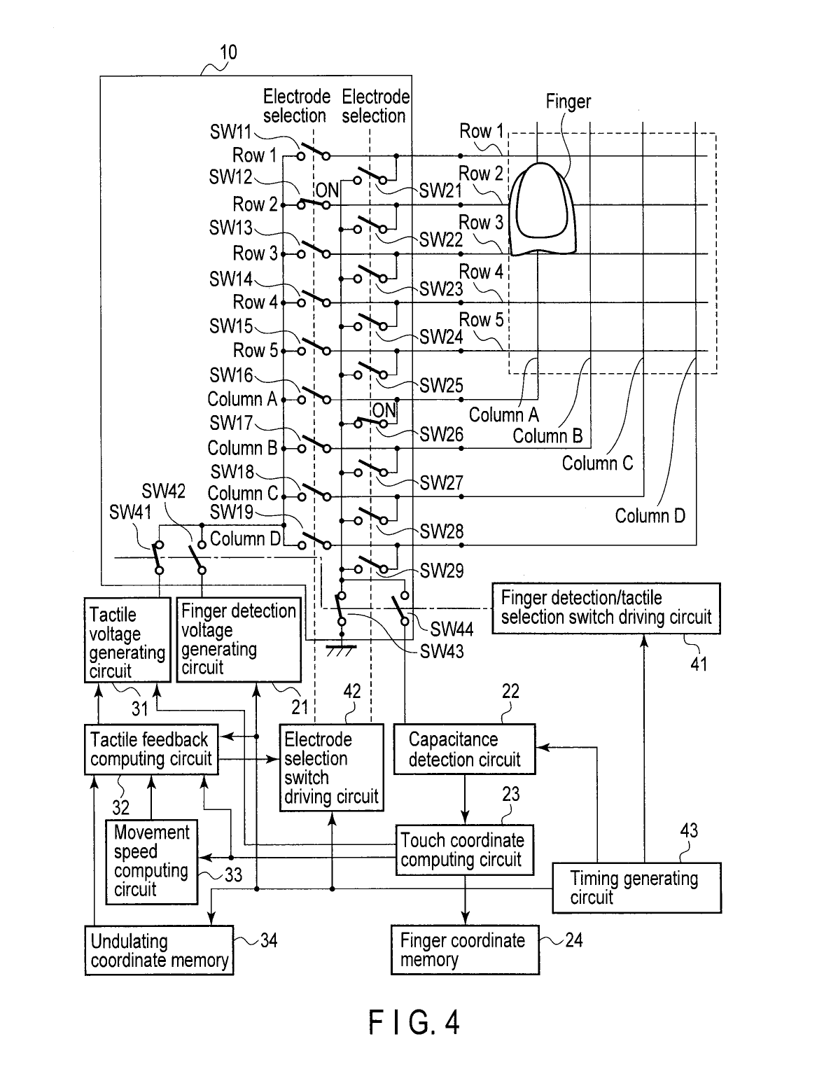

FIG. 4 is a diagram showing a detailed structure of the touchpanel 3 of the display device 1 according to the first embodiment. In FIG. 4, the row electrodes and the column electrodes are represented as rows 1-5 and columns A-D, respectively, to simplify the description.

The switching module 10 comprises a group of a plurality of electrode selection switches. The switching module 10 executes the touch position detection and a tactile voltage output operation to be described later in time division by switching the electrode selection switches. These operations will be described later.

The touch detection module 20 comprises a finger detection voltage generating circuit 21, a capacitance detection circuit 22, a touch coordinate computing circuit 23 and a finger coordinate memory 24. The finger detection voltage generating circuit 21 generates a voltage (for example, 5-20 V) for detecting the finger position on the touchpanel. The capacitance detection circuit 22 detects (measures) capacitance in each position of the electrodes. The touch coordinate computing circuit 23 computes the finger position based on the detected capacitance. The detected finger position coordinate is stored in the finger coordinate memory 24.

The tactile output module 30 comprises a tactile voltage generating circuit 31, a tactile feedback computing circuit 32, a movement speed computing circuit 33 and an undulating coordinate memory 34. The tactile voltage generating circuit 31 generates a tactile voltage. The tactile voltage is set such that a current passing through the electrode to the finger is about 5-100 mA. Tactile sense thereby can be provided to the finger without pain. When the tactile voltage is a direct current, electrical conductivity of the protective cover may be about 1E5Ω/□-1E10Ω/□ or a part of the protective cover on the electrodes may be removed. The tactile voltage is not necessarily direct-current. If the protective cover is a uniform insulator, the same function can be performed by providing an alternate current or pulse shape. The movement speed computing circuit 33 computes a speed at which the finger moves on the touchpanel. The undulating coordinate memory 34 stores three-dimensional uneven (undulating) information on an image displayed on the display module 4 as a background of the touchpanel 3. The tactile feedback computing circuit 32 compensates for the tactile voltage such that the tactile sense provided to the finger is not varied by the movement speed, and unevenness of the background image is detected by the tactile sense.

The control module 40 comprises a finger detection/tactile selection switch driving circuit 41, an electrode selection switch driving circuit 42 and a timing generating circuit 43. At the start of the operation for detecting the finger position or the operation for providing the tactile signal to the finger, the finger detection/tactile selection switch driving circuit 41 switches the electrode selection switches of the switching module in accordance with each of the finger detection operation and the tactile output operation. The electrode selection switch driving circuit 42 drives each switch of the switched electrode selection switches by a predetermined sequence. The timing generating module 43 includes a control operation of the electrode selection switch group and controls the operation of the touchpanel 3.

Next, a structure of the switching module 10 will be described.

One-side ends of the electrode selection switches SW11 to SW15 are connected to one-side ends of the row electrodes, respectively. One-side ends of the electrode selection switches SW16 to SW19 are connected to one-side ends of the column electrodes, respectively. Other-side ends of the electrode selection switches SW11 to SW19 are commonly connected. Common connection points thereof are connected to the tactile voltage generating circuit 31 via the electrode selection switch SW41 and connected to the finger detection voltage generating circuit 21 via the electrode selection switch SW42.

One-side ends of the electrode selection switches SW21 to SW25 are connected to one-side ends of the row electrodes, respectively. One-side ends of the electrode selection switches SW26 to SW29 are connected to one-side ends of the column electrodes, respectively. Other-side ends of the electrode selection switches SW21 to SW29 are commonly connected. Common connection points thereof are connected to a housing ground electrode (earth) via the electrode selection switch SW43 and connected to the capacitance detection circuit 22 via the electrode selection switch SW44.

The electrode selection switches SW41 to SW44 are switched by the finger detection/tactile selection switch driving circuit 41. At the start of the operation for detecting the finger position, the electrode selection switches SW42 and SW44 connect the signal lines and the electrode selection switches SW41 and SW43 open the signal lines. At the start of the operation for providing the tactile signal to the finger, the electrode selection switches SW41 and SW43 connect the signal lines and the electrode selection switches SW42 and SW44 open the signal lines.

Next, the operations of the touchpanel 3 will be described.

FIG. 5 is a driving timing chart in a case where the detection of the finger is executed by a mutual capacitance change of the touch panel 3 of the display device 1 according to the first embodiment.

Time t1-t2 is a finger position detection period, and time t3-t4 is a tactile feedback period. The electrode selection switches SW42 and SW44 are turned on and the signal lines are connected at the timing t1-t2. The electrode selection switches SW41 and SW43 are turned on and the signal lines are connected at the timing t3-t4. The finger position detection period and the tactile feedback period are repeated. A blank time, i.e., time t2-t3 and time t4-t1 do not need to be set.

In the finger position detection period, the electrode selection switch SW26 is turned on, and the electrode selection switches SW11 to SW15 are turned on in order. The finger detection voltage generating circuit 22 generates a finger detection pulse in synchronization with the timing of turning on the electrode selection switches SW11 to SW15 in order, the capacitance detection circuit 22 measures a variation in the voltage of column A at the timing of the pulse generation, and capacitance of each intersection point is thereby detected. A series of these operations is also executed with respect to the electrode selection switches SW27 to SW29. For example, when the finger touches the touchpanel 3 in a position of the intersection point between the electrode in row 2 and the electrode in column A, the detected mutual capacitance is reduced at timing of turning on the electrode selection switch SW12 and the electrode selection switch SW26. The touch coordinate of the finger can thereby be determined.

In the tactile feedback period, a stimulus is generated in the vicinity to the detected finger position, i.e., the intersection point between the electrode in row 2 and the electrode in column A. The electrode selection switch SW12 and the electrode selection switch SW26 are turned on and the tactile voltage generating circuit 31 generates a tactile voltage pulse. During the tactile feedback period, a voltage of the tactile voltage pulse may be varied. Furthermore, an electrode selection switch of a single row electrode and an electrode selection switch of a single column electrode may be turned on, electrode selection switches of a plurality of row electrodes and electrode selection switches of a plurality of column electrodes may be combined, or the combination may be changed on a time-series basis. More complex tactile sense can be obtained by changing the combination on a time-series basis.

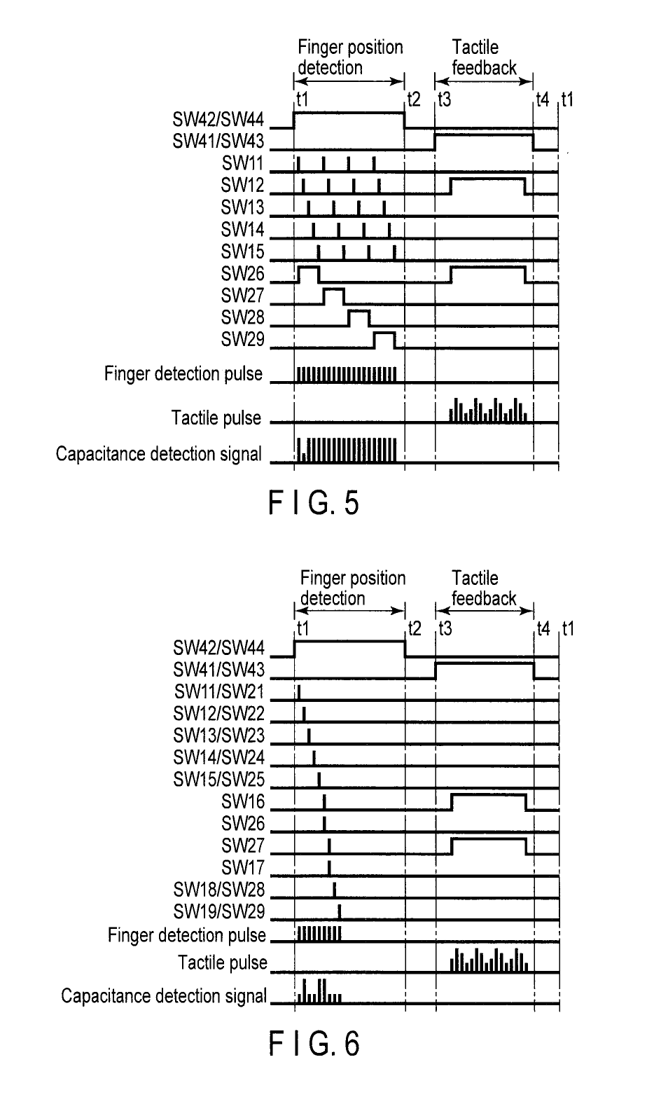

FIG. 6 is a driving timing chart in a case where detection of the finger is executed by a self capacitance change of the touch panel 3 of the display device 1 according to the first embodiment.

Time t1-t2 is a finger position detection period, and time t3-t4 is a tactile feedback period. The electrode selection switches SW42 and SW44 are turned on and the signal lines are connected at the timing t1-t2. The electrode selection switches SW 41 and SW 43 are turned on and the signal lines are connected at the timing t3-t4. The finger position detection period and the tactile feedback period are repeated. A blank time, i.e., time t2-t3 and time t4-t1 do not need to be set.

In the finger position detection period, the capacitance is detected by simultaneously turning on the electrode selection switch SW11 and the electrode selection switch SW21 and measuring the variation of the voltage by the capacitance detection circuit 22. With respect to the electrode selection switches SW12 to SW19 and the electrode selection switches SW22 to SW29, operation for simultaneously turning on selection switches connected to the same electrode is executed in order, and the capacitance is measured.

When the finger touch the touchpanel 3 in the position of the intersection point between the electrode in row 2 and the electrode in column A and a position of an intersection point between the electrode in row 2 and the electrode in column B, the self capacitance measured by the capacitance detection circuit 22 increases at each of timing of turning on the electrode selection switch SW12 and the electrode selection switch SW22, timing of turning on the electrode selection switch SW16 and the electrode selection switch SW26 and timing of turning on the electrode selection switch SW17 and the electrode selection switch SW27. The touch coordinates of the finger thereby can be determined.

In the tactile feedback period, since the finger touch the parallel two lines, i.e., the electrode in column A and the electrode in column B, the tactile sense can be generated by turning on the electrode selection switch SW12, turning on the electrode selection switch SW26 and the electrode selection switch SW27 and generating the tactile voltage pulse by the tactile voltage generating circuit 31. The tactile sense also can be generated by turning on the electrode selection switch SW16 and the electrode selection switch SW27.

During the tactile feedback period, a voltage of the tactile voltage pulse may be varied. Furthermore, an electrode selection switch of a single row electrode and an electrode selection switch of a single column electrode may be turned on, electrode selection switches of a plurality of row electrodes and electrode selection switches of a plurality of column electrodes may be combined, or the combination may be changed on a time-series basis. More complex tactile sense can be obtained without providing electrodes dedicated to the tactile feedback by changing the combination on a time-series basis.

### Second Embodiment

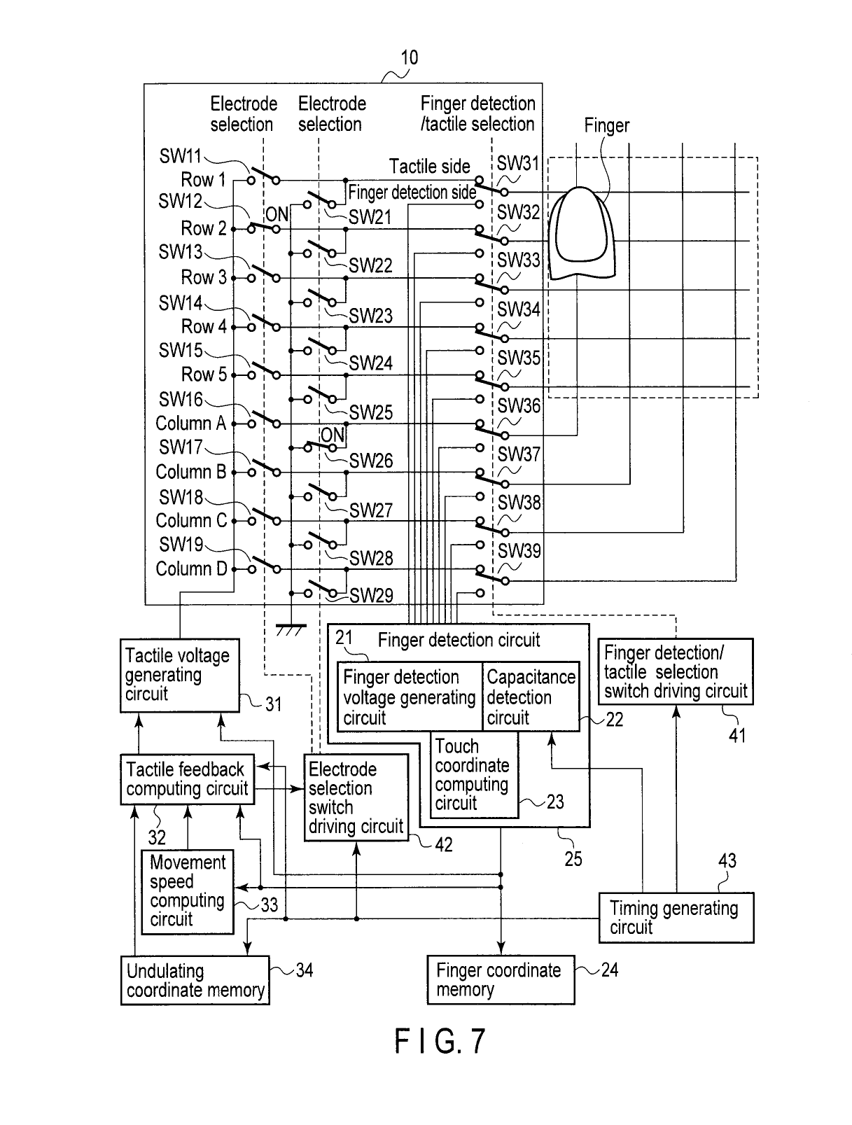

FIG. 7 is a diagram showing a detailed structure of a touchpanel 3 of a display device 1 according to a second embodiment. In FIG. 7, row electrodes and column electrodes are represented as rows 1-5 and columns A-D, respectively, to simplify the description.

The second embodiment is different from the first embodiment in structures of a switching module 10 and a touch detection module 20. Portions comprising the same functions as the portions of the first embodiment are represented by the same reference numerals and their detailed descriptions are omitted.

The touch detection module 20 comprises a finger detection circuit 25 and a finger coordinate memory 24. The finger detection circuit 25 has a structure of integrating the finger detection voltage generating circuit 21, the capacitance detection circuit 22 and the touch coordinate computing circuit 23 in the first embodiment. The finger detection circuit 25 can be formed as, for example, a semiconductor integrated circuit.

Next, the structure of the switching circuit 10 of the second embodiment will be described.

One-side ends of finger detection/tactile selection switches SW31 to SW35 are connected to one-side ends of row electrodes, respectively. One-side ends of finger detection/tactile selection switches SW36 to SW39 are connected to one-side ends of column electrodes, respectively. Other-side ends of the finger detection/tactile selection switches are switchably connected to finger detection side terminals and tactile side terminals. A finger detection/tactile selection switch driving circuit 41 switches the finger detection/tactile selection switches SW31 to SW39 to the finger detection side terminals or the tactile side terminals.

The finger detection side terminals of the finger detection/tactile selection switches SW36 to SW39 are connected to the finger detection voltage generating circuit 21 of the finger detection circuit 25 by signal lines.

One-side ends of electrode selection switches SW11 to SW19 are connected to the tactile side terminals of the finger detection/tactile selection switches SW31 to SW39, respectively. That is, one-side ends of the electrode selection switches SW11 to SW15 are connected to the tactile side terminals which are connected to the row electrodes. One-side ends of the electrode selection switches SW16 to SW19 are connected to the tactile side terminals which are connected to the column electrodes. In addition, other-side ends of the electrode selection switches SW11 to SW19 are commonly connected to a tactile voltage generating circuit 31.

One-side ends of electrode selection switches SW21 to SW29 are connected to the tactile side terminals of the finger detection/tactile selection switches SW31 to SW39, respectively. That is, one-side ends of the electrode selection switches SW21 to SW25 are connected to the tactile side terminal which is connected to the row electrodes. One-side ends of the electrode selection switches SW26 to SW29 is connected to the tactile side terminal which is connected to the column electrodes. In addition, other ends of the electrode selection switches SW21 to SW29 are commonly connected to the housing ground electrode (earth).

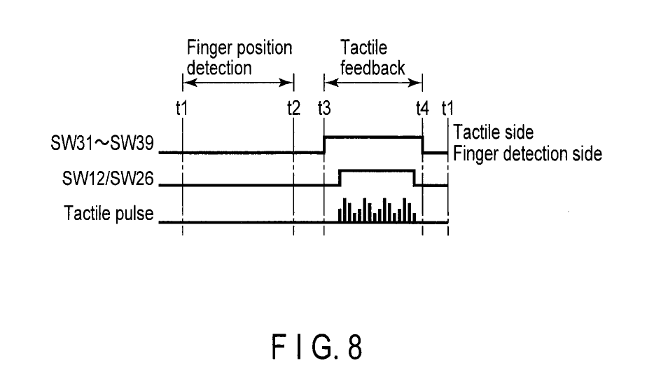

FIG. 8 is a driving timing chart of the touch panel 3 of the display device 1 according to the second embodiment.

Time t1-t2 is a finger position detection period, and time t3-t4 is a tactile feedback period. The finger detection/tactile selection switch driving circuit 41 switches the finger detection/tactile selection switches SW31 to SW39 to the finger detection side at the timing t1-t2, switches the finger detection/tactile selection switches SW31 to SW39 to the tactile side at the timing t3-t4, and connects the signal lines. The finger position detection period and the tactile feedback period are repeated. A blank time, i.e., time t2-t3 and time t4-t1 do not need to be set.

The operations of each of the finger detection voltage generating circuit 21, the capacitance detection circuit 22 and the tactile coordinate computing circuit 23 in the finger detection circuit 25 in the finger position detection period are the same as the operations described by the timing chart shown in FIG. 4 and FIG. 5, thus their descriptions are omitted in FIG. 8.

In the tactile feedback period, an electrode selection switch driving circuit 42 turns on the electrode selection switch SW12 and the electrode selection switch SW26, and the tactile voltage generating circuit 31 outputs a tactile voltage pulse.

### Third Embodiment

In a third embodiment, driving methods of the touchpanel 3 and the display module 4 of the display device 1 according to the first and second embodiments are defined.

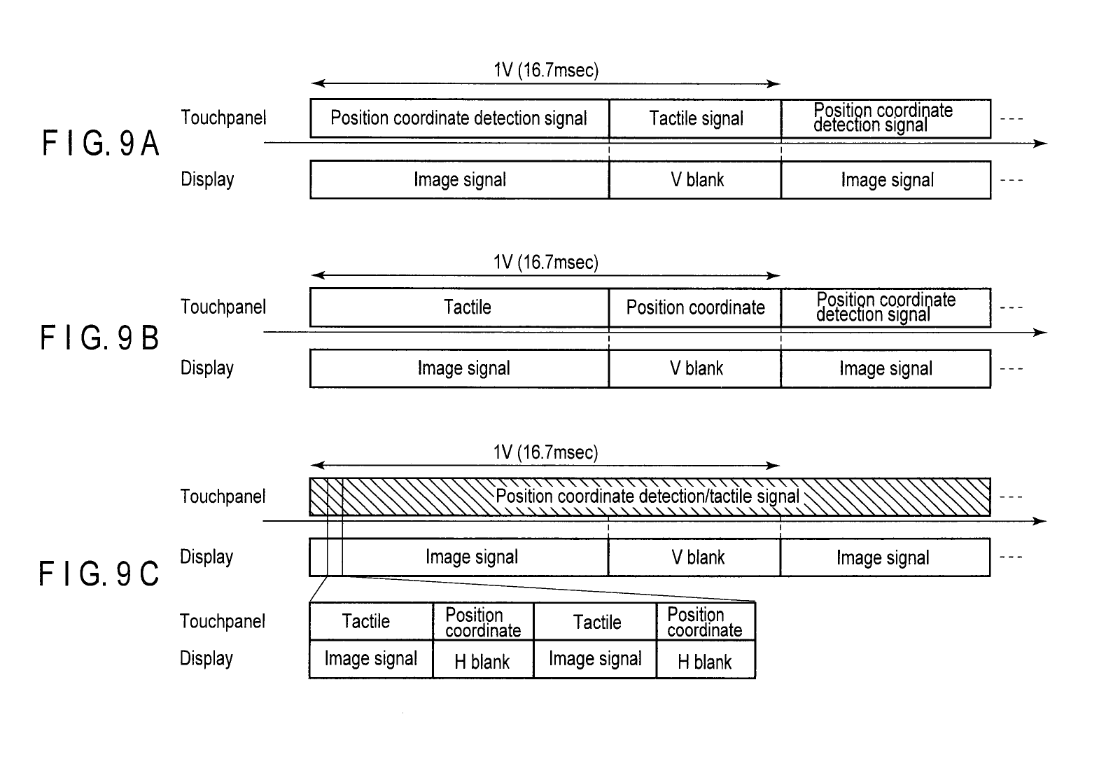

FIG. 9A, FIG. 9B and FIG. 9C are diagrams for illustrating various driving methods of a touchpanel 3 and a display module 4 of a display device 1 according to the third embodiment.

In a driving method shown in FIG. 9A, the touchpanel 3 and the display module 4 are driven in synchronization. That is, a finger position detection period of the touchpanel 3 is started at the same timing as a start of a display period of the display module 4, and a tactile feedback period of the touchpanel 3 is started at the same timing as a start of a V blank period of the display module 4.

In a driving method shown in FIG. 9B, the touchpanel 3 and the display module 4 are driven in synchronization. That is, the tactile feedback period of the touchpanel 3 is started at the same timing as the start of the display period of the display module 4, and the finger position detection period of the touchpanel 3 is started at the same timing as the start of the V blank period of the display module 4.

In a driving method shown in FIG. 9C, the touchpanel 3 and the display module 4 are driven in synchronization. That is, the finger position detection period and the tactile feedback period of the touchpanel 3 are segmented, a part of the tactile feedback period of the touchpanel 3 is driven at output of an image signal within, for example, the display period of 1 H of the display module 4, and a part of the finger position detection period is driven in an H blank period. A part of the finger position detection period of the touchpanel 3 may be driven at the output of the image signal and a part of the tactile feedback period may be driven in the H blank period.

A part of the finger position detection period and a part of the tactile feedback period may be driven in the V blank period or the H blank period alone.

As described above, a touchpanel function and a tactile feedback function can be implemented without giving an influence to an image, by selecting a signal which gives an influence to an image signal, signal to be synchronized in the V blank period or the H blank period.

Driving methods are not limited to the methods shown in FIG. 9A, FIG. 9B and FIG. 9C. The touchpanel 3 and the display module 4 can be independently driven without being synchronized with each other.

### Fourth Embodiment

In a fourth embodiment, various aspects of the detection electrodes of the touchpanel 3 in the display device 1 according to the first and second embodiments are defined.

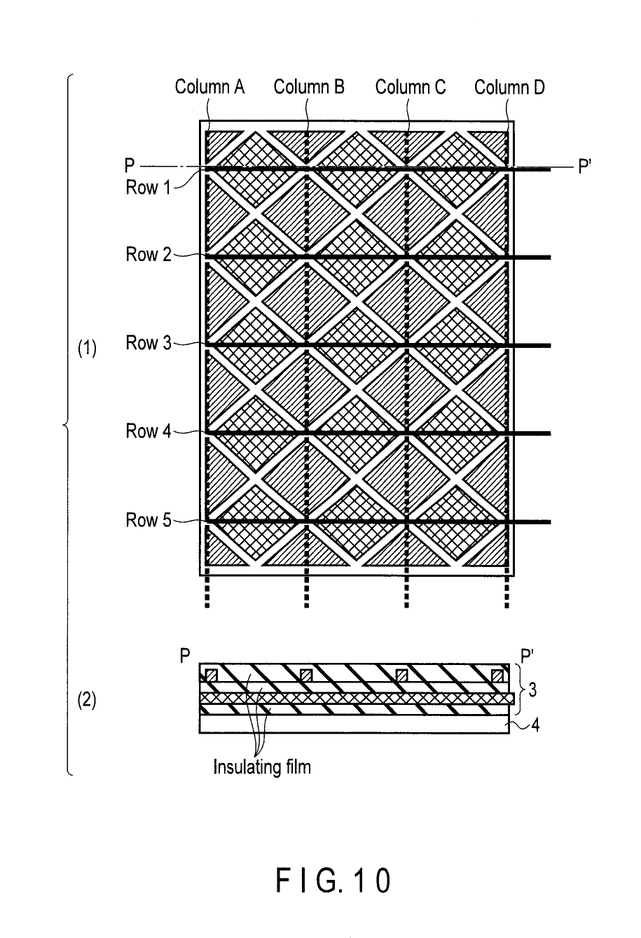

FIG. 10 is an illustration showing a configuration example of electrodes of a touchpanel 3 of a display device 1 according to the fourth embodiment. FIG. 10(1) is a plan view, and FIG. 10(2) is a cross-sectional view seen along arrow P-P′.

Transparent row electrodes and column electrodes are arranged in a matrix in the same layer. The row electrodes and the column electrodes are wired in the same layer, one-side leader lines of the row electrodes and the column electrodes are wired in the same layer, and the other-side leader lines are bridged and connected via an insulating film. The row electrodes and the column electrodes may be wired in a different manner.

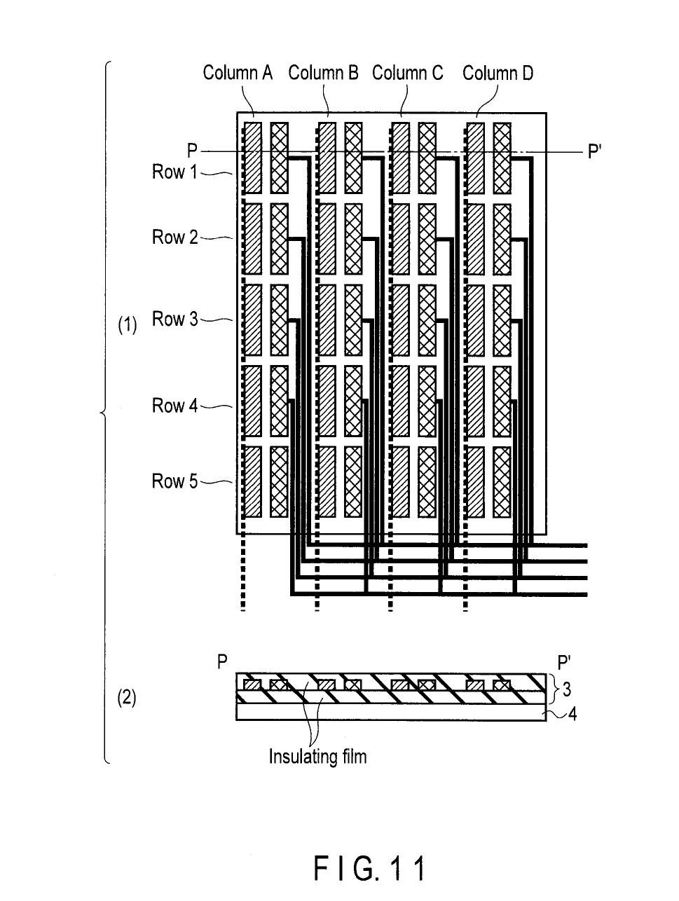

FIG. 11 is an illustration showing a configuration example of the electrodes of the touch panel 3 in the display device 1 according to the fourth embodiment. FIG. 11(1) is a plan view, and FIG. 11(2) is a cross-sectional view seen along arrow P-P′.

All of the transparent row electrodes and column electrodes are arranged in a matrix in the same layer. One-side leader lines of the row electrodes and the column electrodes are commonly wired in the same layer, and the other-side leader lines are separately extended to a termination and used commonly at an outside.

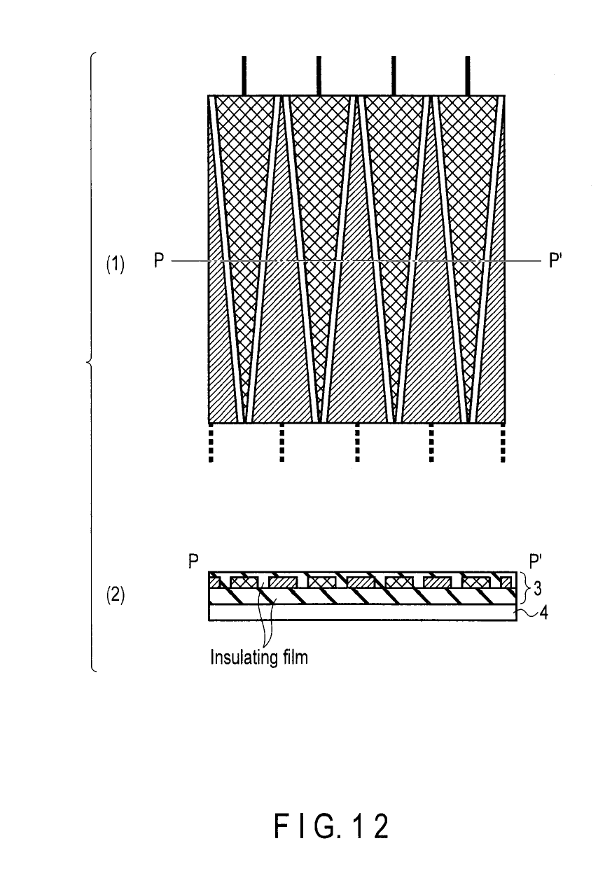

FIG. 12 is an illustration showing a configuration example of the electrodes of the touch panel 3 in the display device 1 according to the fourth embodiment. FIG. 12(1) is a plan view, and FIG. 12(2) is a cross-sectional view seen along arrow P-P′.

A plurality of wedge-shaped electrodes are arranged. Even if the electrodes are arranged in such a manner, the electrodes for finger detection and the electrodes for tactile feedback can be constituted by the same electrodes.

### Fifth Embodiment

In a fifth embodiment, a method for forming the tactile signal of the touchpanel 3 in the display device 1 according to the first and second embodiments is defined.

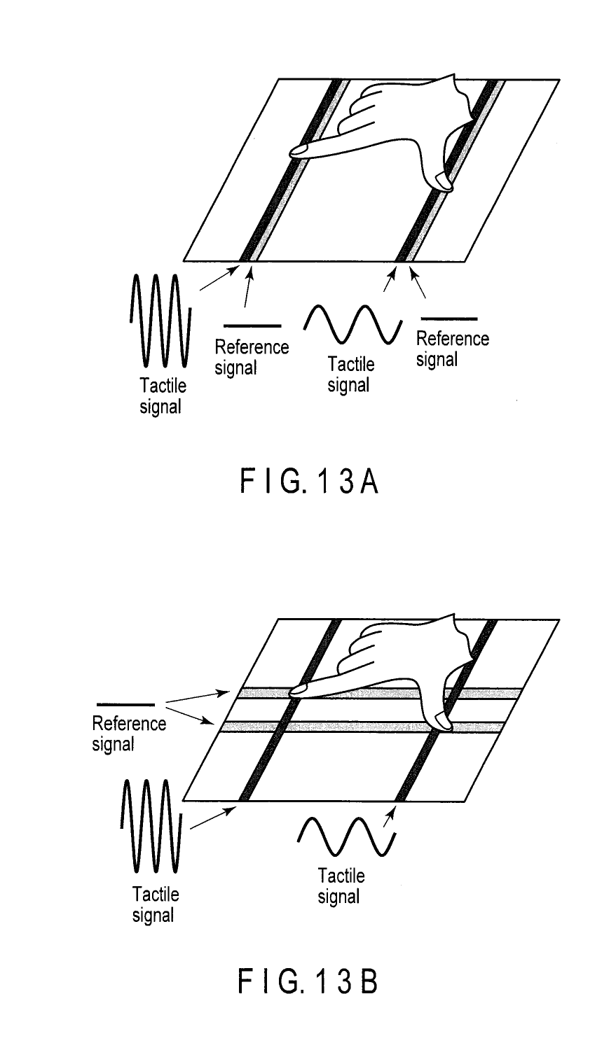

FIG. 13A and FIG. 13B are illustrations showing a structure of a tactile signal of a touch panel 3 in a display device 1 according to a fifth embodiment.

In FIG. 13A, a sensible stimulus is provided by applying a tactile pulse signal to one of adjacent electrodes in an even-numbered column and an odd-numbered column, applying a reference signal such as a GND potential to the other electrode, and simultaneously touching the tactile signal and the reference signal at least one contact point.

The tactile pulse signal can provide different sensible stimuli by varying amplitude and frequency of the signals. Different feeling can also be provided at a plurality of contact points by switching electrodes to which the tactile signal is applied in order.

In FIG. 13B, the tactile pulse signal is applied to one of intersecting electrodes, and the reference signal such as the GND potential is applied to the other electrode.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A touchpanel comprising:
a plurality of electrodes arranged in each of a first direction and a second direction crossing the first direction on the touchpanel;
a touch detection module comprising a detection signal output module configured to supply a signal for detecting a position of a conductor on the touchpanel to each of the electrodes, and a position computing module configured to compute the position of the conductor based on a signal output from the electrode in accordance with the supplied signal;
a tactile output module configured to output a tactile signal to an electrode in a vicinity to the position of the conductor;
a switching module configured to switch between a signal line from the touch detection module and a signal line from the tactile output module, and to connect the signal line to a signal line from each of the electrodes; and
a control module configured to control operations of the touch detection module, the tactile output module and the switching module.

2. The touchpanel according to claim 1, further comprising:
a first selection switch group having one-side ends connected to wiring lines from the respective electrodes;
a first changeover switch configured to switch and connect a wiring line, to which other-side ends of the first switch group are commonly connected, to the detection signal output module and the tactile output module;
a second selection switch group having one-side ends connected to the wiring lines from the respective electrodes; and
a second changeover switch configured to switchably connect a wiring line, to which other-side ends of the second switch group are commonly connected, to the position computing module and a ground,
wherein the control module controls switching operations of the first and second selection switch groups by switching the first and second changeover switches to select the detection signal output module and the position computing module when the position of the conductor is detected, and switching the first and second changeover switches to select the tactile output module and the ground when the tactile signal is output.

3. The touchpanel according to claim 1, further comprising:
a changeover switch group configured to switch between connections of the wiring lines from the respective electrodes to tactile side terminals and finger detection side terminals;
a first selection switch group having one-side ends connected to wiring lines from the tactile side terminals; and
a second selection switch group having one-side ends connected to the lines from the respective tactile side terminals,
wherein wiring lines from other-side ends of the first selection switch group are connected to the tactile output module,
wiring lines from other-side ends of the second selection switch group are connected to ground,
wiring lines from the finger detection side terminals are connected to the detection signal output module and the position computing module, and
the control module controls switching operations of the first and second selection switch groups by switching the changeover switch group to the finger detection side terminals when the position of the conductor is detected, and switching the changeover switch group to the tactile side terminals when the tactile signal is output.

4. The touchpanel according to claim 3, wherein the detection signal output module and the position computing module are integrated.

5. The touchpanel according to claim 1, wherein the tactile signal is a voltage pulse.

6. The touchpanel according to claim 5, wherein the control module selects electrodes of at least one row and at least one column as electrodes to which the tactile signal is applied.

7. The touchpanel according to claim 6, wherein the control module changes a combination of the electrodes to which the tactile signal is applied on a time-series basis.

8. A display device comprising:
a display panel on which display elements are arrayed in a matrix; and
a touchpanel piled on the display panel,
the touchpanel comprising:
a plurality of electrodes arranged in each of a first direction and a second direction crossing the first direction on the touchpanel;
a touch detection module comprising a detection signal output module configured to supply a signal for detecting a position of a conductor on the touchpanel to each of the electrodes, and a position computing module configured to compute the position of the conductor based on a signal output from the electrodes in accordance with the supplied signal;
a tactile output module configured to output a tactile signal to an electrode in a vicinity to the position of the conductor;
a switching module configured to switch between a signal line from the touch detection module and a signal line from the tactile output module, and to connect the signal line to a signal line from each of the electrodes; and
a control module configured to control operations of the touch detection module, the tactile output module and the switching module, the control module being further configured to control a display operation of the display panel.

9. The device according to claim 8, wherein the control module controls a conductor position detection operation and a tactile signal addition operation of the touchpanel, and the display operation of the display panel, synchronously with one another.

10. The device according to claim 8, wherein the control module controls a conductor position detection operation and a tactile signal addition operation of the touchpanel, and the display operation of the display panel, independently of one another.

11. The device according to claim 8, wherein the touchpanel further comprises:
a first selection switch group having one-side ends connected to wiring lines from the electrodes;
a first changeover switch configured to switch and connect a wiring line, to which other-side ends of the first switch group are commonly connected, to the detection signal output module and the tactile output module;
a second selection switch group having one-side ends are connected to the wiring lines from the respective electrodes; and
a second changeover switch configured to switchably connect a wiring line, to which other-side ends of the second switch group are commonly connected, to the position computing module and a ground, and
the control module controls switching operations of the first and second selection switch groups by switching the first and second changeover switches to select the detection signal output module and the position computing module when the position of the conductor is detected, and switching the first and second changeover switches to select the tactile output module and the ground when the tactile signal is output.

12. The device according to claim 11, wherein the control module controls a conductor position detection operation and a tactile signal addition operation of the touchpanel, and the display operation of the display panel, synchronously with one another.

13. The device according to claim 11, wherein the control module controls a conductor position detection operation and a tactile signal addition operation of the touchpanel, and the display operation of the display panel, independently of one another.

14. The device according to claim 8, wherein the touchpanel further comprises:
a changeover switch group configured to switch between connections of the wiring lines from the respective electrodes to tactile side terminals and finger detection side terminals;
a first selection switch group having one-side ends connected to wiring lines from the tactile side terminals; and
a second selection switch group having one-side ends connected to the lines from the respective tactile side terminals,
wiring lines from other-side ends of the first selection switch group are connected to the tactile output module,
wiring lines from other-side ends of the second selection switch group are connected to ground,
wiring lines from the finger detection side terminals are connected to the detection signal output module and the position computing module, and
the control module controls switching operations of the first and second selection switch groups by switching the changeover switch group to the finger detection side terminals when the position of the conductor is detected, and switching the changeover switch group to the tactile side terminals when the tactile signal is output.

15. The device according to claim 14, wherein the control module controls a conductor position detection operation and a tactile signal addition operation of the touchpanel, and the display operation of the display panel, synchronously with one another.

16. The device according to claim 14, wherein the control module controls a conductor position detection operation and a tactile signal addition operation of the touchpanel, and the display operation of the display panel, independently of one another.

17. The touchpanel according to claim 8, wherein the tactile signal is a voltage pulse.

18. The device according to claim 17, wherein the control module controls a conductor position detection operation and a tactile signal addition operation of the touchpanel, and the display operation of the display panel, synchronously with one another.

19. The device according to claim 17, wherein the control module controls a conductor position detection operation and a tactile signal addition operation of the touchpanel, and the display operation of the display panel, independently of one another.
